(19) United States
(12) Patent Application Publication
(10) Pub. No.: US 2015/0233177 A1
(43) Pub. Date: Aug. 20, 2015

(54) ENERGY-EFFICIENT FENESTRATION ASSEMBLIES

(71) Applicant: CLEAR WALL CORPORATION, Felton, CA (US)

(72) Inventor: Normand Marchand, Felton, CA (US)

(21) Appl. No.: 14/426,380

(22) PCT Filed: Sep. 6, 2013
(86) PCT No.: PCT/US2013/058628

§ 371 Date: Mar. 5, 2015

Related U.S. Application Data
(60) Provisional application No. 61/697,796, filed on Sep. 6, 2012.

(51) Int. Cl. E06B 9/24; E06B 9/52; E06B 1/52; E06B 5/00; E06B 1/36

(52) U.S. Cl. CPC E06B 9/24; E06B 5/00; E06B 1/36; E06B 1/52; E06B 9/522

(57) ABSTRACT

Energy-efficient fenestration assemblies that effectively secure substrates, such as window films, are described. The fenestration assembly includes: (1) a base frame capable of having secured thereon a substrate; and (2) a tensioner capable of engaging with the base frame such that when the base frame has secured thereon the substrate, the tensioner places the substrate under tension relative to the base frame.

### FIELD

The present invention relates generally to fenestration assemblies. More particularly, the present invention relates to fenestration assemblies that effectively secure substrates, such as energy-efficient window films.

### BACKGROUND

Fenestration means products that fill openings in a building envelope, such as windows, doors, skylights, curtain walls, etc., that are designed to permit the passage of air, light, vehicles, or people. A building envelope, in turn, generally refers to the separation between the interior and the exterior environments of a building. It serves as the outer shell to protect the indoor environment as well as to facilitate its climate control.

In order to increase a building's energy efficiency, and to decrease the loads on a building's air conditioning and heating systems, fenestration assemblies are used to cover the interior of a building's window frame cavity with transparent window film. By way of example, using such a window/film combination in the winter season causes interior light to reflect back inside, trapping a relatively greater amount of heat inside the building envelope. Conversely, in the summer season, a relatively large amount of exterior light is reflected back to the exterior of the building, allowing cooler temperatures to prevail inside the building envelope.

What is therefore needed are energy-efficient systems and methods that reduce the load on air conditioning units regulating the temperature inside the building envelope in an economical, time-efficient, and effective.

### SUMMARY

In one aspect, the present teachings provide a fenestration assembly. The fenestration assembly includes: (1) a base frame capable of having secured thereon a substrate; (2) a tensioner capable of engaging with the base frame such that when the base frame has secured thereon the substrate, the tensioner places the substrate under tension relative to the base frame. Preferably, the substrate is window film, and is more preferably a transparent window film.

In preferred embodiments of the present teachings, the tensioner includes a male member and the base frame includes a female region, and when the tensioner engages with the base frame, the male member occupies and contacts at least a portion of the female region. The male member may include a protruding region having one or more crimps thereon, the female region surrounds and has defined therein a cavity region, which has serrations thereon, and in an engaged position of the tensioner with the base frame, the crimps on the protruding region are disposed adjacent to the serrations of the cavity region. Further, the tensioner may comprise a substrate grip that is capable of gripping the substrate when the base frame engages with the tensioner. The base frame may comprise a substrate tape bed and the substrate grip grips the substrate when the base frame engages with the tensioner.

In certain embodiments of the present arrangements, the tensioner comprises one or more nipples capable of applying tension to the substrate when the base frame engages with the tensioner. In some of these embodiments, the base frame comprises a sloped region, and the one or more nipples is disposed proximate to the slope region when the base frame engages with the tensioner. In this configuration, the sloped region forces the substrate, which is disposed between the base frame and the tensioner, toward the tensioner. This facilitates disposing a stable and/or requisitely tense substrate between the tensioner and the base frame. In certain aspects of the present arrangements, the base frame includes a tension enhancer that enhances the tension when the substrate is disposed between the base frame and the tensioner.

Preferably, the base frame also includes a compressible material track capable of receiving compressible material, which compresses and expands when the fenestration assembly is being installed inside a window frame cavity. In alternate embodiments of the present arrangements, however, the tensioner includes a compressible material track capable of receiving compressible material, which compresses and expands when the fenestration assembly is being installed inside a window frame cavity. Thus, the compressible material track may be part of the base frame or part of the tensioner.

In another aspect, the present teachings disclose a process for building a fenestration assembly. The process includes: (1) placing a substrate on a base frame, and (2) engaging and/or mating a tensioner with the base frame such that the tensioner places the secured substrate in tension relative to the base frame. Preferably, the placing is carried out by taping the substrate to the base frame. More preferably, taping includes adhering the substrate to a tape bed area on the base frame.

In preferred embodiments of the present arrangements, the above-described process includes applying an additional force to the tensioner and/or the base frame to facilitate the engaging and/or mating of the base frame and the tensioner. Applying, as mentioned above, may be carried out using at least one device chosen from a group comprising hammer, roller, and presser.

In another aspect, the present teachings provide a process of building a fenestration assembly. The process includes: (1) building a base frame having a cambered profile; (2) placing a substrate on the base frame; (3) transforming the cambered profile of the base frame to a non-cambered profile; and (4) engaging and/or mating a tensioner with the base frame having a non-cambered profile. Preferably, transforming includes applying an external force to transform from the cambered profile to the non-cambered profile, and further includes ceasing to apply the external force after engaging and/or mating the tensioner with the base frame.

The construction and method of operation, however, together with additional objects and advantages thereof will be best understood from the following descriptions of specific embodiments when read in connection with the accompanying figures.

### BRIEF DESCRIPTION OF THE DRAWINGS

FIG. 1 shows a side-sectional view of a tensioner, according to one preferred embodiment of the present arrangements, used to grip and apply tension to a substrate when the present fenestration assembly is in an assembled state.

FIG. 2 shows a side-sectional view of a base frame, according to one preferred embodiment of the present arrangements, used to secure a substrate when the present fenestration assembly is in an assembled state.

FIG. 3 shows a side-sectional view of a fenestration assembly in an assembled state, according to one preferred embodiment of the present arrangements, having secured thereon a substrate.

FIG. 4 shows a side-sectional view of a tensioner, according to an alternate embodiment of the present arrangements, capable of holding a compressible material, and used to grip and apply tension to a substrate when the fenestration assemblies of the present teachings are in an assembled state.

FIG. 5 shows a side-sectional view of a base frame, according to an alternate embodiment of the present arrangements, that the tensioner of FIG. 4 engages with in an assembled state of the two components.

FIG. 6 shows a side-sectional view of a base frame, according to another alternate embodiment of the present arrangements, that includes a tension enhancer.

FIG. 7 shows a top view of a base frame, according to one preferred embodiment of the present arrangements, which transforms from a cambered profile to a non-cambered profile.

FIG. 8 shows a front view of an assembled window frame according to one preferred embodiment of the present arrangements.

FIG. 9 shows a flowchart showing a process, according to one embodiment of the present teachings, for assembling fenestration assemblies of the present arrangements.

### DETAILED DESCRIPTION OF THE PREFERRED EMBODIMENTS

In the following description numerous specific details are set forth in order to provide a thorough understanding of the present teachings. It will be apparent, however, to one skilled in the art that the present teachings may be practiced without limitation to some or all of these specific details. In other instances, well known process steps have not been described in detail in order to not unnecessarily obscure the present teachings.

The present teachings provide a fenestration assembly that is used for securing substrates, such as transparent window film, for energy efficiency applications. The present teachings also offer a process for assembling such fenestration assemblies. In preferred embodiments, the present fenestration assemblies include a tensioner and a base frame, both of which engage and/or mate with each other, to secure firmly a substrate therebetween.

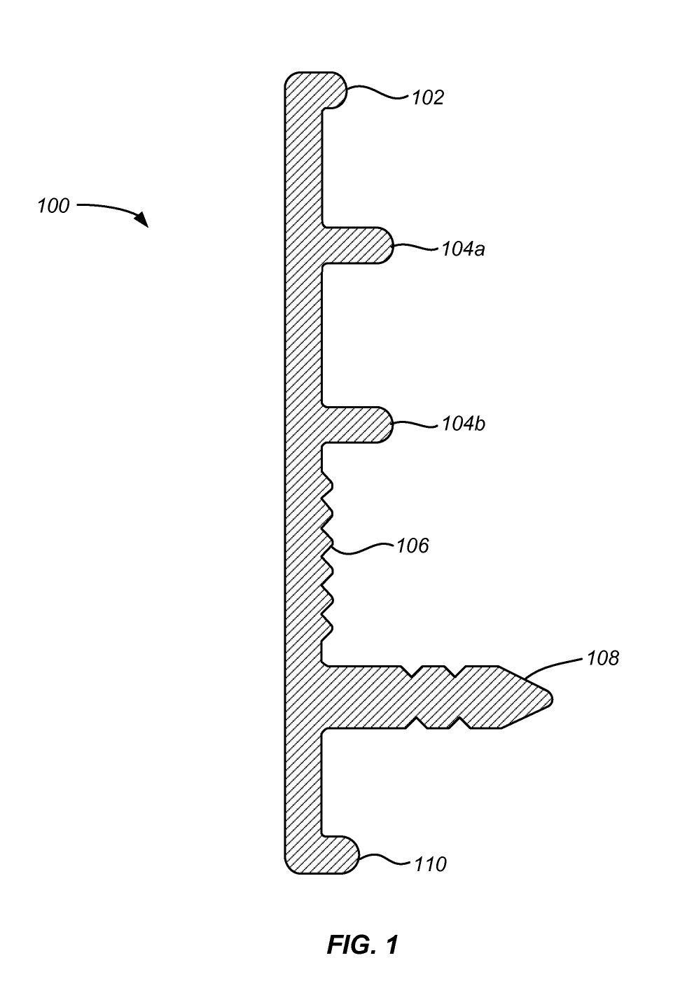

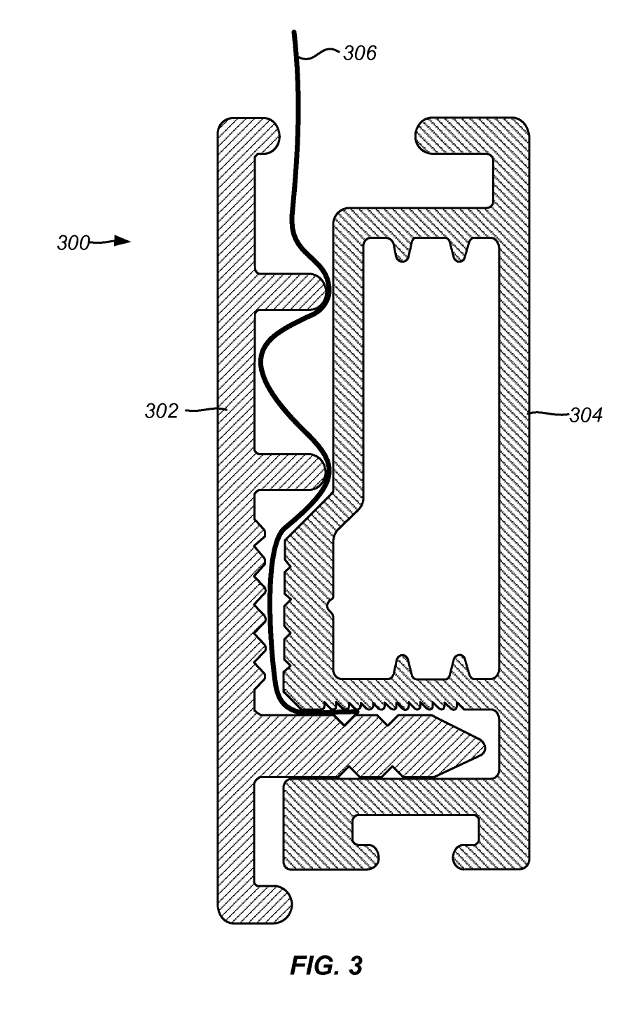

FIG. 1 shows a side-sectional view of a tensioner 100, according to one preferred embodiment of the present arrangements, for gripping and applying tension to a substrate. Tensioner 100 is one component of a fenestration assembly, which in an assembled state (shown below with reference to FIG. 3), is used to increase energy efficiency when installed over an opening or a window frame cavity of a building. Preferably, the substrate is window film, and is more preferably a transparent window film. When installed, the present fenestration assembly provides significant reduction in transmission of heat through an opening or a window frame cavity, resulting in increased energy efficiency and decreased loads on a building's heating and air conditioning systems.

Tensioner 100 includes an endcap 102 disposed at a first end and an endcap 110 disposed at a second end. A protruding nipple 104a and protruding nipple 104b are each disposed adjacent to endcap 102, preferably proximate to a middle of a length of tensioner 100. A protruding male member 108 is disposed adjacent to endcap 110. A film grip region 106 is disposed between nipple 104b and male member 108.

Endcap 102 and endcap 110 are designed to cap tensioner 100 at each end. The function of endcap 102 and endcap 110, in certain embodiments of the present arrangements, is largely aesthetic, providing smooth edges that are more pleasing to the viewer when the present fenestration assembly is installed over an opening or a window frame cavity.

Though the embodiment of FIG. 1 shows endcap 102 and endcap 110 each with an L-shaped configuration, the present teachings recognize that alternate shapes may be employed for each or either of endcap 102 and endcap 110. By way of example, endcap 102 or endcap 110 may each or both be fabricated as a straight edge. In the L-shaped configuration shown in the embodiment of FIG. 1, a portion of endcap 102 relatively perpendicular to the tensioner preferably extends outwardly between about 0.04 inches and about 0.06 inches from the base of the tensioner, though certain other embodiments of the present arrangements have a variance of up to about 75% of these values. Preferably, endcap 102 does not directly contact a substrate when the fenestration assemblies of the present teachings are in an assembled state. A portion of endcap 110 relatively perpendicular to tensioner 100 outwardly extends between about 0.05 inches and about 0.07 inches from the base of tensioner 100, though certain other embodiments of the present arrangements have a variance of about 75% of these values. Alternate embodiments of the present arrangements use different lengths and different sizes for each of endcaps 102 and 110, and some embodiments do not require use of an endcap.

Nipple 104a and nipple 104b are each a protruding portion of tensioner 100 designed to increase tension of a substrate, according to preferred embodiments of the present arrangements, when the fenestration assemblies are in an assembled state. As will be explained in more detail below, in an assembled state of the fenestration assemblies, protruding nipples 104a and 104b each push a portion of a secured substrate, creating additional tension in the substrate. The additional tension in the substrate offers a tighter fit, which provides a relatively transparent, glare-free, and more aesthetically pleasing window film when the present fenestration assemblies are installed. Though FIG. 1 shows a tensioner that includes two nipples, the present teachings contemplate use of any number of nipples to increase or decrease window film tension to desired levels. In alternate embodiments of the present teachings, however, a nipple is not used. Though the embodiment of FIG. 1 shows nipples 104a and 104b each extending at an approximately 90° angle from the length of tensioner 100, the present teachings recognize that nipples 104a and 104b may extend from the length of tensioner 100 at any angle, so long as each of nipples 104a and 104b is capable of applying tension to a substrate when the present fenestration assemblies are in an assembled state.

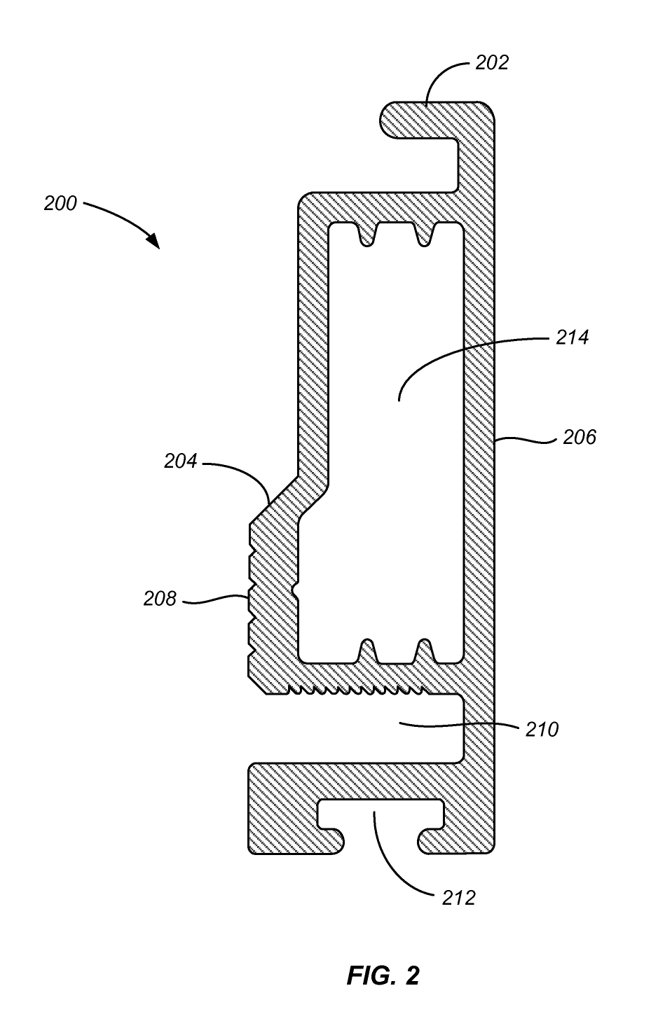

According to preferred embodiments of the present arrangements, nipples 104a and 104b protrude between about 0.015 inches and about 0.215 inches from the base of tensioner 100, though certain other embodiments of the present arrangements have a variance of about 75% of these values. In alternate embodiments of the present arrangements, nipple 104a and nipple 104b may be of varying lengths, so long as each provides sufficient clearance between tensioner 100 and a corresponding base frame (described below with reference to FIG. 2) to secure a substrate when the present fenestration assemblies are in an assembled state.

Male member 108, according to preferred embodiments of the present arrangements, is another protruding portion of tensioner 100. As shown below with reference to the embodiment of FIG. 3, when the present fenestration assemblies are in an engaged state, at least a portion of protruding male member 108 pushes a substrate into a corresponding female part (described below with reference to FIG. 2) that receives protruding male member 108 and secures the substrate in the fenestration assemblies of the present teachings. To this end, male member 108 may include crimps on at least one end that engage with a serrated surface of the female cavity region, thus securing the substrate therein. According to the embodiment of FIG. 1, the crimps of male member 108 form an indentation in male member 108 of approximately 90°, though alternate embodiments may employ crimps of varying angles, so long as they are capable of engaging with the serrations of the female region (described below with reference to FIGS. 2 and 3). In other embodiments of the present arrangements, male member 108 is fabricated without crimps, so long as male member 108 is capable of securing a substrate when engaged with the female region of the base frame.

The present teachings thus provide the advantage of additional stability of the substrate over other methods of stabilizing a substrate, such as tape, glue, rubber mounting, screws, nails, or the like. Thus, the present teachings also provide an advantage of assembled fenestration assemblies that require relatively few materials and supplies, thus reducing the expense and time necessary to create and assemble fenestration assemblies. Finally, the present teachings provide for fenestration assemblies that last longer and require replacement or replacement of parts less often, because, for example, tape will lose its ability to affix a substrate over time; or nails or screws will often tear a substrate, particularly when the tension of the substrate is relatively high. Thus, the present teachings provide a more cost-effective and efficient means of securing a substrate over a window frame cavity.

While the embodiment of FIG. 1 shows male member 108 extending perpendicularly away from the length of tensioner 100 at an approximately 90° angle, the present teachings recognize that male member 108 may extend from tensioner 100 at any angle, so long as some portion of male member 108 is capable of being received by the female region of a corresponding base frame (described below with reference to FIGS. 2 and 3) in a manner that will secure a substrate in the present fenestration assemblies. In preferred embodiments of the present arrangements, male member 108 protrudes between about 0.282 inches and about 0.482 inches from the length of tensioner 100, though certain other embodiments of the present arrangements have a variance of about 75% of these values. In alternate embodiments of the present arrangements, male member 108 may be of varying lengths, so long as some portion of male member 108 is capable of being received by, and securing a substrate in, a corresponding female region.

Film grip region 106 is disposed between nipple 104b and male member 108. In preferred embodiments of the present arrangements, film grip region 106 comprises a serrated edge of tensioner 100, capable of gripping a substrate. A substrate is gripped by the serrations of film grip region 106 when region 106 engages with the corresponding serrated tape bed area of the base frame (explained below with reference to FIG. 3). The length of film grip region 106 preferably is between about 0.27 inches and about 0.47 inches from the base of tensioner 100, though certain other embodiments of the present arrangements have a variance of about 75% of these values. In certain embodiments, the length of film grip region 106 is any value, so long as it grips a substrate that is used in the present fenestration assemblies.

The serrations of film grip region 106 have a pitch value that is preferably between about 0.04 inches and about 0.06 inches, though certain other embodiments of the present arrangements have a variance of about 75% of these values. In alternate embodiments of the present arrangements, film grip region 106 is not serrated and forms a relatively flat surface.

FIG. 2 shows a side-sectional view of a base frame 200, according to one preferred embodiment of the present arrangements, that engages with a corresponding tensioner (e.g., tensioner 100 of FIG. 1). Base frame 200 includes an endcap 202 disposed at a first end and a compressible material track 212 disposed at a second end. On a first side of base frame 200, a viewing area 206 is disposed between endcap 202 and compressible material track 212. On a second side of base frame 200, across from viewing area 206, a female region 210 is disposed adjacent to compressible material track 212. A tape bed area 208 is disposed adjacent to female region 210. A slope region 204 is disposed adjacent to tape bed area 208.

Compressible material track 212, according to preferred embodiments of the present arrangements, receives a compressible material capable of tightly securing the present fenestration assemblies in a window envelope and preventing air infiltration through the assembly when installed. Accordingly, when assembled, compressible material is disposed in compressible material track 212 on an outer edge of an assembled fenestration assembly. The height and width of the inner cavity of compressible material track 212 may be any width capable of receiving a compressible material. The width of the inner cavity of compressible material track 212 is preferably a value that is between about 0.025 inches and about 0.225 inches in width, though certain other embodiments of the present arrangements have a variance of about 75% of these values. The height of compressible material track 212 is a value that is preferably between about 0.04 inches and about 0.06 inches, though certain other embodiments of the present arrangements have a variance of about 75% of these values.

The opening to the inner cavity of compressible material track 212 is preferably some width less than the inner cavity region, which is capable of securing a compressible material inside compressible material track 212. In preferred embodiments of the present arrangements, the compressible material is foam, though the present teachings recognize that any material known to those in the prior art, capable of compressing due to the application of pressure, may be used. By way of example, in certain embodiments of the present arrangements, a spring is used. In alternate embodiments of the present arrangements, a compressible material track is not used. In such embodiments, compressible material is affixed to an outer edge of an assembled fenestration assembly. In certain other embodiments, however, compressible material is not used.

Though not shown in FIG. 2, in an operative state, the compressible material housed inside compressible material track 212 will extend beyond the outer edge of base frame 200. In this manner, the compressible material forms a portion of the present fenestration assembly that abuts the window frame cavity when the present fenestration assembly is installed. When installed, the compressible material compresses against the edge of the window frame cavity, tightly securing the present fenestration assembly inside the window frame cavity.

After installation of the assembly, e.g., inside a window frame cavity, the compressible material is compressed between the assembly and the window frame, creating a relatively secure and air-tight fit. In this compressed state, the present teachings provide the further advantage of insulation by significantly reducing, and preferably eliminating, air passage through the present fenestration assembly. Thus, the present teachings recognize that air infiltration through a fenestration assembly will reduce the energy efficiency gained by use of a substrate. Accordingly, the present arrangements provide the ability to greatly reduce or prevent such air infiltration.

In alternate embodiments of the present arrangements, the present fenestration assembly may be installed over a window frame cavity by use of magnetic strips secured on the assembly. In such embodiments, the present teachings contemplate component parts of a fenestration assembly (e.g., a base frame or a tensioner) that are not fabricated with a compressible material track.

Female region 210, according to preferred embodiments of the present arrangements, is disposed adjacent to compressible material track 212. Female region 210 comprises a cavity capable of receiving at least a portion of a corresponding male member of a tensioner (e.g., male member 108 of tensioner 100 of FIG. 1) when the present fenestration assembly is in an assembled state. Female region 210 includes serrations on at least one end of the inner surface of the cavity disposed therein. In preferred embodiments of the present arrangements, the cavity of female region 210 is capable of receiving a substantial portion of a male member, though the present teachings recognize that the cavity of female region 210 may be any size, so long as it is capable of receiving a portion of a male member. Preferably, the height of female region 210 is a value that is between about 0.015 inches and about 0.025 inches, though certain other embodiments of the present arrangements have a variance of about 75% of these values. Preferably, the length of female region 210 is a value that is between about 0.25 inches and about 0.45 inches, though certain other embodiments of the present arrangements have a variance of about 75% of these values.

As shown below with reference to FIG. 3, in an assembled state, at least a portion of a male member of a tensioner 302 pushes a substrate into the female region of a base frame 304. In this manner, the substrate is secured between one or more corresponding crimps on the male member of tensioner 302 and at least a portion of one serrated edge of the female region's cavity. This mating configuration realizes the advantage of increased stability and tension.

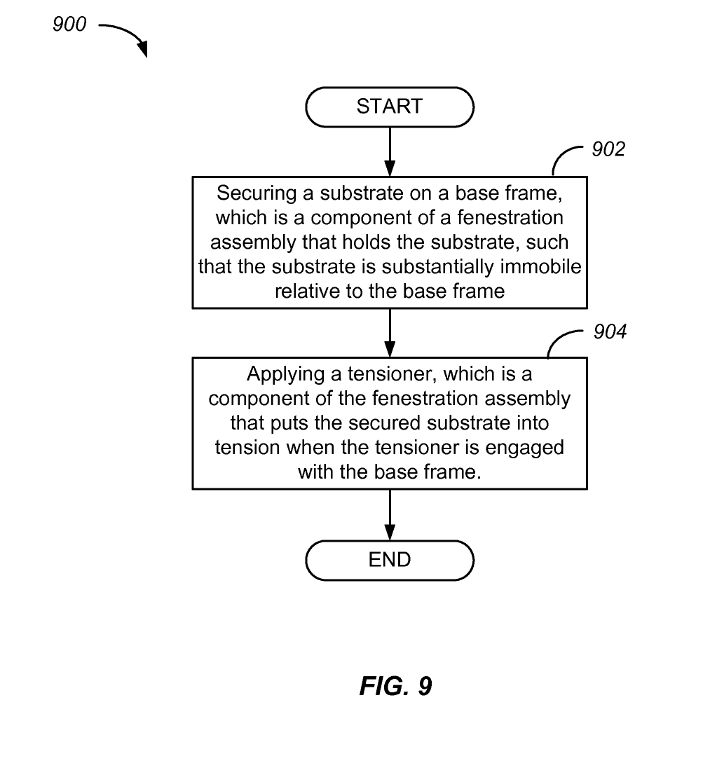

Tape bed area 208 is capable of securing a substrate on the present base frame prior to and during engagement of a tensioner (e.g., tensioner 100 of FIG. 1) with base frame 200. As explained below with reference to step 901 of FIG. 9, when the component parts of the present fenestration assembly, i.e., the tensioner, the base frame, and the substrate, are being assembled, two-sided tape is preferably applied to the tape bed area such that the tape receives and stabilizes the substrate prior to engagement of a tensioner to a base frame (described further below with reference to FIG. 3). The length of tape bed area may be a value that is between about 0.2 inches and about 0.4 inches, though certain other embodiments of the present arrangements have a variance of about 75% of these values. Preferably, the pitch value for the serrations of tape bed area is a value that is between about 0.02 inches and about 0.08 inches, though certain other embodiments of the present arrangements have a variance of about 75% of these values. In alternate embodiments of the present arrangements, the pitch value of the serrations of the tape bed area may be any value so long as the serrations are capable of securing a substrate. In certain alternate embodiments of the present arrangements, however, a tape bed area is used to secure a substrate using alternate means that are not tape, e.g., nails. In certain other embodiments, however, a tape bed area is not used.

The tape bed area preferably comprises a serrated edge that, when the present fenestration assembly is in an assembled state, engages with a corresponding serrated edge of a tensioner's film grip area (e.g., film grip area 106 of FIG. 1). In this manner, the engaged film grip and tape bed regions provide additional stability and the required tension to the substrate when the present fenestration assemblies are installed.

A slope region 204 provides a distance, or a gap, between a tape bed area disposed on a first end of the slope region, and an opposite end of the slope region. When the present fenestration assemblies are in an assembled state, the nipples of a tensioner may be received by any point after slope region 204. The gap created by the two ends of slope region 204 and the tensioner accommodate one or more nipples of tensioner 100 of FIG. 1. According to preferred embodiments of the present arrangements, the substrate is secured by an engaged and/or mating configuration of the tensioner's male member and the base portion's female region, the interface between the film grip region and the tape bed region, and nipples pushing into a portion of the substrate, which is adjacent to locations on the base frame after the slope region. Accordingly, the present teachings realize the advantage of increased stability and/or tension applied to the substrate when fenestration assembly 300 is in an assembled state.

Though FIG. 2 shows the slope of slope region 204 at an approximately 45° angle relative to adjacent tape bed area 208, the present teachings contemplate the use of any angle, so long as the slope creates a region proximate to slope region 204 that is sufficient to receive a corresponding nipple of a tensioner. Preferably, the angle of slope region 204 is a value that is between about 30° and about 60° relative to adjacent tape bed area 208.

As shown in FIG. 2, viewing area 206 spans the length of one side of base frame 200. Viewing area 206 may be a region of base frame 200 that, when the fenestration assembly is assembled and installed, is an outer surface of the fenestration assembly. In other words, this may be the portion of the assembly that is visible to an observer inside a building envelope. In alternate embodiments of the present arrangements, however, a backside of the tensioner is the portion of the assembly that is visible to an observer inside a building envelope. In other words, in such embodiments, a back side of a tensioner represents a viewing area.

Endcap 202 is designed to cap base frame 200 at a first end. Though the embodiment of FIG. 2 shows endcap 202 with an L-shaped configuration, alternate embodiments of the present arrangements use varying shapes for endcap 202. By way of example, in certain embodiments, endcap 202 is configured as a straight edge.

FIG. 3 shows a side-sectional view of an assembled fenestration assembly 300, according to one preferred embodiment of the present arrangements. Assembled fenestration assembly 300 includes a tensioner 302 engaged with a base frame 304 and a substrate 306 therebetween. As shown in the embodiment of FIG. 3, substrate 306 is secured between the corresponding crimps of a male member (e.g., male member 108 of FIG. 1) and the serrated edge of the inner surface of the cavity of a female region (e.g., female region 210 of FIG. 2). Likewise, substrate 306 is further secured by gripping between the corresponding serrated edges of tensioner 306's film grip region (e.g., film grip region 106 of FIG. 1) and the base frame's tape bed region (e.g., similar to tape bed region 208 of FIG. 2). Further, the tape bed region provides stability to a substrate disposed on a base prior to engagement between the tensioner and the base frame. The tape bed area, preferably using two-sided tape, secures the substrate to the base frame.

Further, as shown in the embodiment of FIG. 3, the protruding nipple of tensioner 302 pushes substrate 306 against the gap created proximate to the slope region of base frame 304. A gap refers to a space created between a base frame and a tensioner when they are in a mating and/or engaged configuration. In this manner, the nipple produces additional tension in substrate 306. Thus, the present teachings realize the advantage of a substrate installed not only with stability, but also with additional tension. This arrangement provides a relatively transparent and glare-free means of using energy-efficient window film over a window frame cavity.

Tensioner 302 and base frame 304 are composed of any rigid material capable of stabilizing substrate 306 and being installed in a window frame cavity as part of the present fenestration assembly. Representative materials to make tensioner 302 and base frame 304 include at least one member chosen from a group comprising aluminum, steel, graphite, plastic, glass, wood, and composites.

According to preferred embodiments of the present arrangements, tensioner 302 and base frame 304 are each fabricated as contiguous structures. Alternate embodiments of the present arrangements, however, contemplate fabrication of one or more parts of tensioner 302 or base frame 304 separately. By way of example, male member 108 may be fabricated separately from the other component parts of tensioner 302, and is then connected to tensioner 302 by any method known to those skilled in the art. In such embodiments, separate parts may be fabricated using different materials.

Preferably, substrate 306 used by fenestration assembly 300 is any window film, and more preferably, transparent window film, that increases a window's energy-efficient and is capable of being secured by the present fenestration assembly. By way of example, Silver 35, which is commercially available from 3M Corporation of Minneapolis, Minn., may be used. Preferably, however, V-kool 70, which is commercially available from Southwall Technologies Inc. of Palo Alto, Calif., is used.

In one embodiment of the present arrangements, the window film can be any thickness so long as it can be secured in the frame and is not too flimsy. In certain embodiments of the present arrangements, the thickness of the window film depends on the dimensions of the window, which is ultimately covered by the fenestration assembly of the present teachings. Preferably, however, window film is between about 1 mm and about 30 mm in thickness. In a more preferred embodiment of the present arrangements, window film is between about 6 mm and about 12 mm in thickness, and in even more preferred embodiments of the present arrangements, window film is between about 8 mm and about 10 mm in thickness.

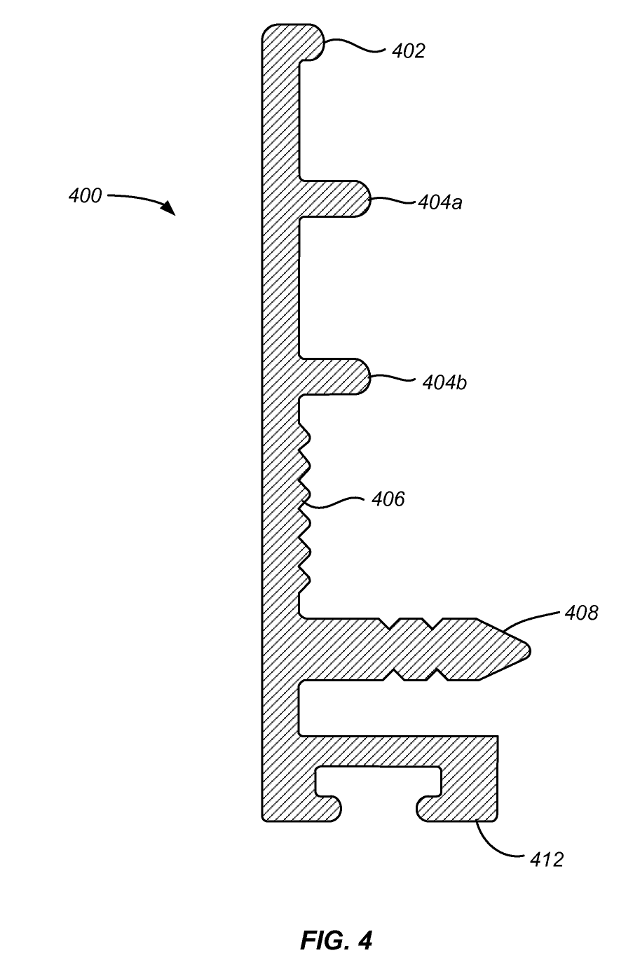

FIG. 4 shows a side-sectional view of a tensioner 400, according to an alternate embodiment of the present arrangements. Tensioner 400 includes an endcap 402, nipples 404a and 404b, a film-grip region 406, and a male member 408, which are substantially similar to their counterparts in FIG. 1. Unlike the embodiment of FIG. 1, however, the embodiment of FIG. 4 replaces endcap 102 of FIG. 1 with a compressible material track 412, which is substantially similar to compressible material track 212 of FIG. 2.

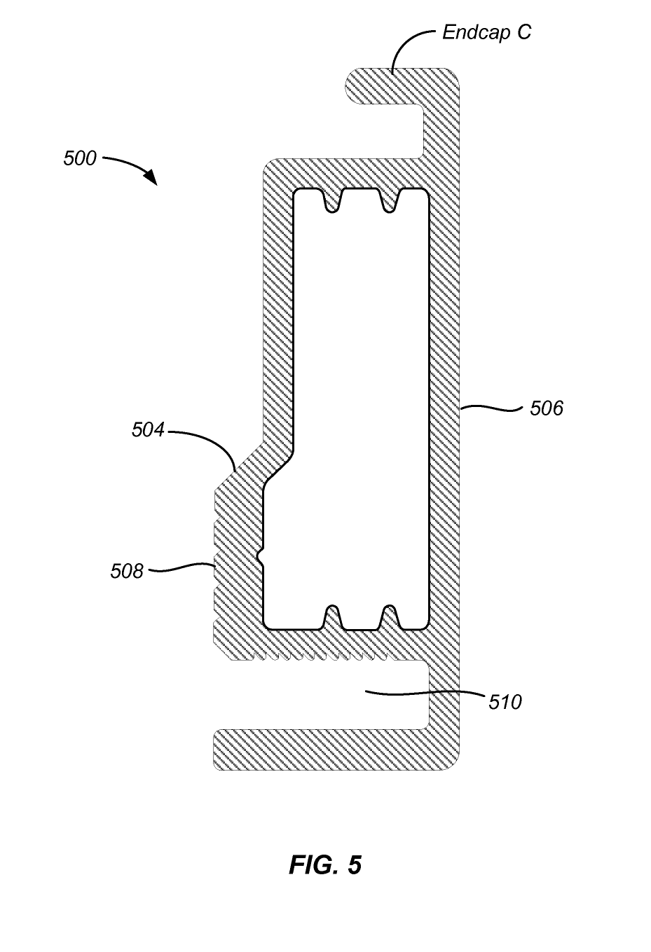

FIG. 5 shows a side-sectional view of a base frame 500, according to an alternate embodiment of the present arrangements. Base frame 500 includes an endcap 502, a slope region 504, a viewing area region 506, a tape bed area 508, and a female region 510, which are substantially similar to their counterparts in FIG. 3. Unlike base frame 300 of FIG. 3, however, base frame 500 of FIG. 5 does not include a compressible material track disposed adjacent to female region 510.

Tensioner 400 of FIG. 4 is designed to engage with base frame 500 of FIG. 5 such that a substrate is secured therebetween. The resulting fenestration assembly operates in a substantially similar manner to the assembled fenestration assembly 300 shown in FIG. 3. In other words, though certain parts of tensioner 400 and base frame 500 have essentially been moved from one component to another (relative to FIGS. 1 and 2, respectively), these components still engage and/or mate as shown in FIG. 3.

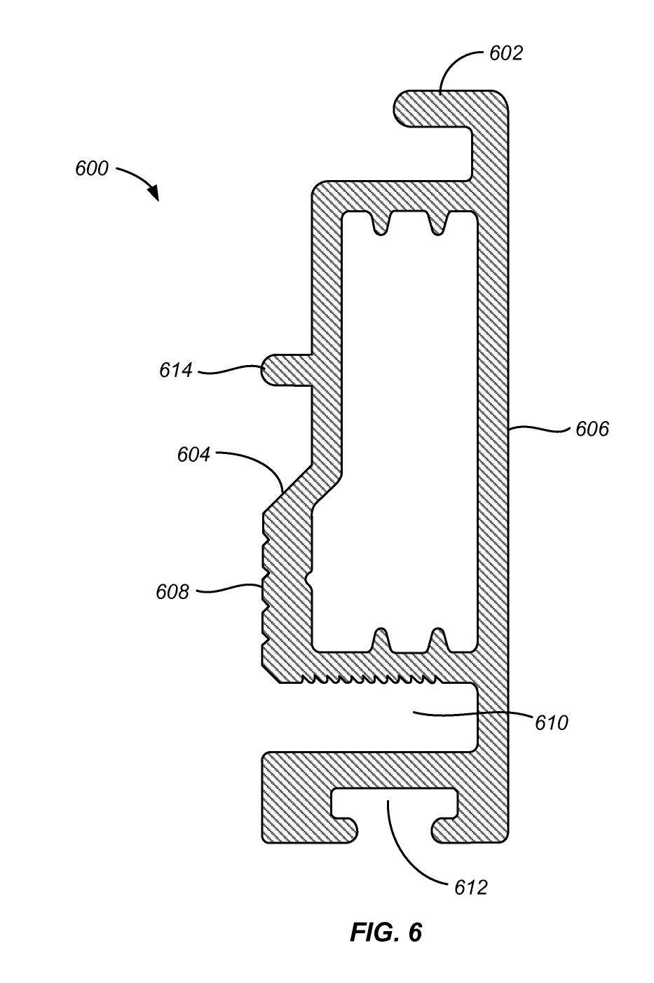

FIG. 6 shows a base frame 600, according to one alternate embodiment of the present arrangements. Base frame 600 includes an endcap 602, a slope region 604, a viewing area 606, a tape bed area 608, a female region 610, and a compressible material track 612, which are substantially similar to their counterparts in FIG. 2. The embodiment of FIG. 6, however, also includes a protruding tension enhancer 614 disposed adjacent to slope region 604. When base frame 600 engages with a tensioner (e.g., tensioner 100 of FIG. 1), tension enhancer 614 adds additional tension to the substrate by pushing against a substrate. In an assembled state of the tensioner and the base frame, the substrate is disposed along a “serpentine” pathway, where a first portion of the substrate is pushed by the nipple of the tensioner toward the base frame, and a second, adjacent portion of the substrate is pushed in direction of the tensioner by the tension enhancer of the base frame. As a result, the one or more nipples of the tensioner work in conjunction with the tension enhancer of the base frame to provide a high level of tension on the substrate.

Though the embodiment of FIG. 6 shows base frame 600 with one tension enhancer 614, alternate embodiments of the present arrangements utilize a plurality of tension enhancers fabricated on or attached to base frame 600. Likewise, according to other embodiments of the present arrangements, one or more tension enhancers 614 may be fabricated on or connected to tensioner 600. In such embodiments, each additional tension enhancer 614 produces additional tension on a substrate.

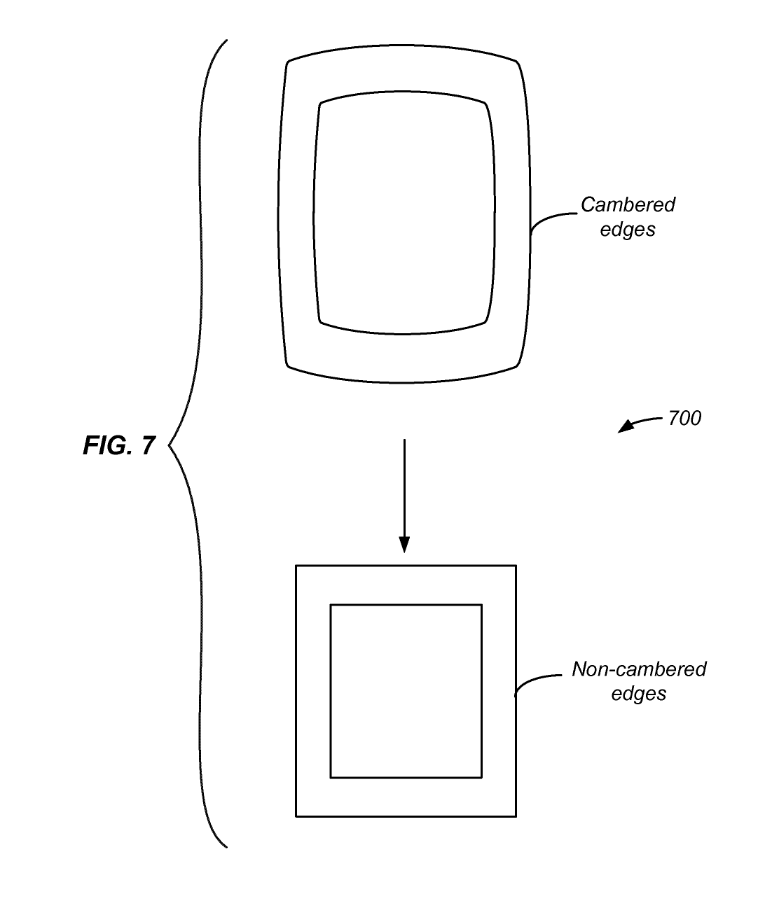

FIG. 7 shows a top view of a base frame used in a fenestration assembly, according to one preferred embodiment of the arrangements, which transforms from a cambered profile to a non-cambered profile during assembly of the present fenestration assemblies. In preferred embodiments of the present arrangements, a base frame (e.g., base frame 200 of FIG. 2) and/or a tensioner (e.g., tensioner 100 of FIG. 1) are fabricated with a cambered profile. However, the present teachings propose that this cambered profile should be transformed to a non-cambered profile after a substrate is secured between the tensioner and the base frame. Such a transformation puts the substrate in a requisite tension that also makes it stable. A cambered base frame and/or tensioner may be straightened on each edge by engaging with clamps configured to stabilize a base frame in a non-cambered profile.

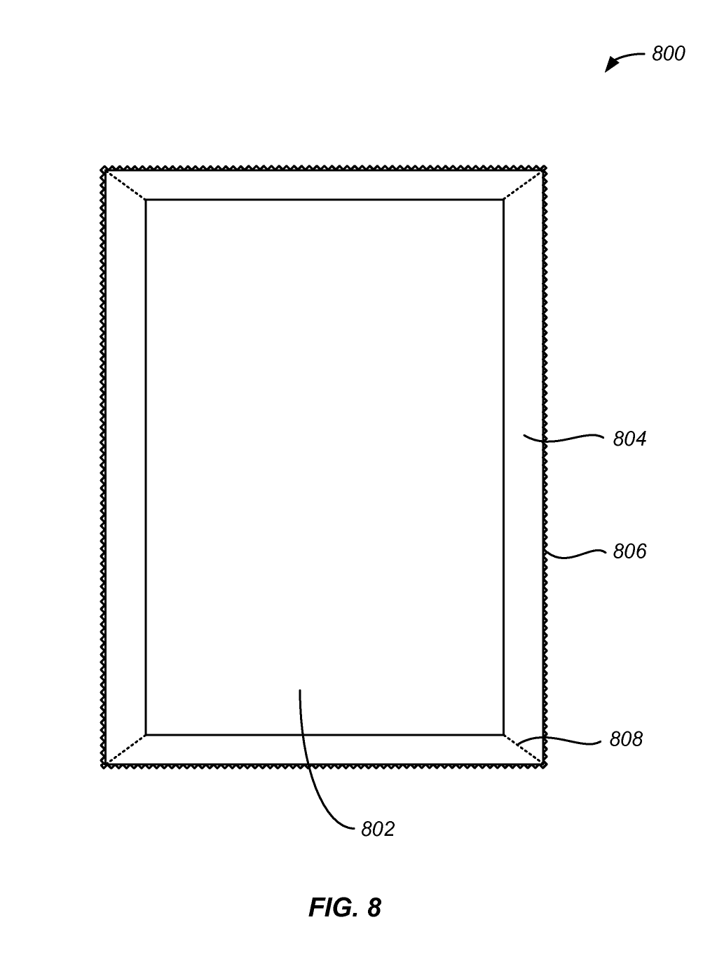

FIG. 8 shows a front view of a fenestration assembly 800, according to one preferred embodiment of the present arrangements. Assembly 800 includes a substrate 802, a viewing area 804, a compressible material 806, and a sealed portion 808. Substrate 802 is substantially similar to substrate 306 of FIG. 3. Viewing area 804 is substantially similar to viewing area 206 of FIG. 2. Compressible material is installed in a compressible material track (e.g., compressible material track 212 of FIG. 2), as discussed above.

With reference to fenestration assembly 800 of FIG. 8, four straight base frame and tensioner components are arranged at approximately right angles relative to each other to form a base frame and a tensioner. The base frame and the tensioner mate and/or engage to form fenestration assembly 800 of FIG. 8. In order to facilitate connection between the discrete fenestration assembly segments, the ends of each base frame and/or tensioner components are sealed at sealed portion 808. The present teachings recognize that sealed portion 808 may be sealed in any manner well known to those skilled in the art, but that sealing by welding represents the preferred embodiment of the present invention. In one embodiment of fenestration assembly 800, abutting base frame and/or tensioner components have complementary profiles to minimize gaps that are to be sealed.

FIG. 9 shows a flowchart 900 for a method for assembling a fenestration assembly (e.g., fenestration assembly 300 of FIG. 3), according to preferred embodiments of the present arrangements. Process 900 begins with a step 902, which includes placing a film or a substrate on a base frame (e.g., base frame 100 of FIG. 1). In this step, the film or substrate is preferably substantially immobile relative to the base frame. The substrate may be secured on the base frame by any method known to those skilled in the art. By way of example (described above with reference to FIG. 2), adhering two-sided tape on the tape bed area of the base frame allows the substrate to be secured when attached to that tape. This is particularly useful when the substrate being used is relatively large. Furthermore, when a relatively larger substrate is placed on a base frame, a residual portion of the substrate that extends beyond the boundary of the base frame is cut off. This allows the dimensions of the base frame and the substrate to be coextensive with respect to each other. At the conclusion of step 902, a substrate/base frame sub-assembly is formed.

Next, a step 804 includes applying a tensioner to the substrate/base frame subassembly. Such an assembled configuration is shown in FIG. 3, for example. The tensioner may be applied to the substrate/base frame sub-assembly by any method known to those skilled in the art. By way of example, sufficient force to insert at least a portion of the male member of a tensioner (e.g., tensioner 100 of FIG. 1) into the female region of a base frame (e.g., base frame 200 of FIG. 2) may be applied. To this end, a hammer or a roller may be used.

Although illustrative embodiments of these arrangements have been shown and described, other modifications, changes, and substitutions are intended. Accordingly, it is appropriate that the appended claims be construed broadly and in a manner consistent with the scope of the disclosure, as set forth in the following claims.

What is claimed is:

1. A fenestration assembly, comprising:
a base frame capable of having secured thereon a substrate; and
a tensioner capable of engaging with said base frame such that when said base frame has secured thereon said substrate, said tensioner places said substrate under tension relative to said base frame.

2. The fenestration assembly of claim 1, wherein said substrate is a window film.

3. The fenestration assembly of claim 1, wherein said tensioner includes a male member and said base frame includes a female region, and when said tensioner engages with said base frame, said male member occupies and contacts at least a portion of said female region.

4. The fenestration assembly of claim 3, wherein said male member includes a protruding region having one or more crimps thereon.

5. The fenestration assembly of claim 4, wherein said female region surrounds and has defined therein a cavity region, which has serrations thereon.

6. The fenestration assembly of claim 5, wherein in an engaged position of said tensioner with said base frame, said crimps on said protruding region are disposed adjacent to said serrations of said cavity region.

7. The fenestration assembly of claim 1, wherein said tensioner comprises a substrate grip capable of gripping said substrate when said base frame engages with said tensioner.

8. The fenestration assembly of claim 7, wherein said base frame comprises a substrate tape bed and said substrate grip grips said substrate when said base frame engages with said tensioner.

9. The fenestration assembly of claim 1, wherein said tensioner comprises one or more nipples capable of applying tension to said substrate when said base frame engages with said tensioner.

10. The fenestration assembly of claim 9, wherein said base frame comprises a sloped region and said nipple is disposed proximate to said slope region when said base frame engages with said tensioner.

11. The fenestration assembly of claim 1, wherein said base frame includes a compressible material track capable of receiving compressible material, which compresses and expands when said fenestration assembly is being installed inside a window frame cavity.

12. The fenestration assembly of claim 1, wherein said tensioner includes a compressible material track capable of receiving compressible material, which compresses and expands when said fenestration assembly is being installed inside a window frame cavity.

13. The fenestration assembly of claim 1, wherein said base frame includes a tension enhancer that enhances the tension on the substrate as said substrate is disposed between said base frame and said tensioner when said base frame and said tensioner are in an engaged position.

14. A process of building a fenestration assembly, said process comprising:
securing a substrate on a base frame; and
engaging and/or mating a tensioner with said base frame such that said tensioner places said film in tension relative to said base frame.

15. The process of building said fenestration assembly of claim 14, wherein said securing is carried out by taping said substrate to said base frame.

16. The process of building said fenestration assembly of claim 15, wherein said taping includes adhering said substrate to a tape bed area on said base frame.

17. The process of building said fenestration assembly of claim 16, further comprising applying additional force to said tensioner and/or said base frame in their engaged position.

18. The process of building said fenestration assembly of claim 17, wherein said applying is carried out using at least one device chosen from a group comprising hammer, roller, and presser.

19. The process of building said fenestration assembly of claim 17, wherein said applying is carried out using hydraulic force.

20. A process of building a fenestration assembly, said process comprising:
building a base frame having a cambered profile;
placing a substrate on said base frame;
transforming said cambered profile of said base frame to a non-cambered profile; and
engaging and/or mating a tensioner with said base frame having a non-cambered profile.

21. The process of building said fenestration assembly of claim 20, wherein said transforming includes applying an external force to transform from said cambered profile to said non-cambered profile and further comprising ceasing to apply said external force after said engaging and/or mating said tensioner with said base frame.
